(19) United States
(12) Patent Application Publication
(10) Pub. No.: US 2006/0171654 A1
(43) Pub. Date: Aug. 3, 2006

(54) Integrated planar microfluidic bioanalytical systems

(76) Inventors: Aaron R. Hawkins, Provo, UT (US); Bridget Peeni, Provo, UT (US); John Barber, Provo, UT (US); Adam T. Woolley, Orem, UT (US); Holger Schmidt, Capitola, CA (US); Milton L. Lee, Pleasant Grove, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 11/336,646

(22) Filed: Jan. 20, 2006

Related U.S. Application Data
(63) Continuation-in-part of application No. 10/868,475, filed on Jun. 15, 2004.
(60) Provisional application No. 60/646,184, filed on Jan. 20, 2005.

(51) Int. Cl. G02B 6/00

(52) U.S. Cl. 385/147

(57) ABSTRACT

A system and method for performing rapid, automated and high peak capacity separations of complex protein mixtures through the combination of fluidic and electrical elements on an integrated circuit, utilizing planar thin-film micromachining for both fluidic and electrical components.

### CROSS REFERENCE TO RELATED APPLICATIONS

This document claims priority to, and incorporates by reference all of the subject matter included in the provisional patent application docket number 05-01, having Ser. No. 60/646,184 and filed on Jan. 20, 2005. This document also claims priority to the co-pending patent application Ser. No. 10/868,475 filed on Jun. 15, 2004.

### BACKGROUND OF THE INVENTION

1. Field of the Invention

This invention relates generally to microfabrication processes for microfluidics. More specifically, the invention is a system and method of microfabrication that use planar, thin-film microfabrication techniques from which microfluidic and microelectronic components are combined on a substrate to perform bioanalytical microfluidic operations.

2. Description of Related Art

An increasing need for the detection and quantification of biological molecules in medicine, biochemistry, and biology has driven a rapid expansion in the analysis of biomolecules. Innovations in bioanalytical chemistry have enhanced the ability to characterize a wide range of analytes, including metabolites, neurotransmitters, nucleic acids, carbohydrates, peptides and proteins. The continued development of new tools and techniques that improve sensitivity, selectivity, speed and throughput in biological analysis, while reducing cost per assay, are critical in clinical diagnosis, medical research, and other disciplines in the life sciences.

A major interest in bioanalytical chemistry is the separation and identification of proteins. The distribution of proteins in biological materials is sensitive to cellular conditions, and consists of proteins having abundances that are dependent on age, disease state(s), and environmental conditions (e.g., nutrients, medicines, temperature, stress, etc.). Marker proteins, whose expressions change during the progression of a disease, have been associated with certain human ailments such as cancer, Alzheimer's disease, schizophrenia, and Parkinson's disease, to name a few. Measurements of such target proteins are becoming increasingly important in clinical assays for human disorders and disease.

Quantitative analysis of protein expression profiles has been proposed as a means to diagnose the overall state (e.g., wellness) of the biological system from which they were obtained. In order to take advantage of this extremely promising diagnostic potential, appropriate methodologies must be developed to rapidly separate, identify, and quantify target proteins in various samples of interest, including body fluids, tissues, and cells.

Unfortunately, protein analysis is an extremely challenging task because of the sheer number of proteins in biological systems and their dynamic nature. There are vastly different concentrations of the various proteins; for a given cell, the abundance of different proteins may vary by over a factor of a million, while in the blood the dynamic range of protein concentrations may be greater than ten orders of magnitude. Moreover, numerous interactions occur among proteins and other ligands, and expressed proteins are often further modified by reactions such as phosphorylation, glycosylation, carbamylation, deamidation, and truncation. Considering that current studies place the number of genes in the human genome to be about 22,000 and that there are many more proteins than genes, the enormity of the analytical problem is clearly evident. It has been estimated that there are approximately 1,500,000 different proteins expressed in humans. Clearly, sophisticated new analytical techniques with extremely high peak capacities and very large dynamic detection ranges are needed.

Currently, the most popular method for separating a large number of proteins is two-dimensional (2-D) gel electrophoresis. Using this technique, proteins are separated in one dimension by isoelectric point (pI) and in a second dimension by size. Although 2-D gel electrophoresis can resolve more than 1,000 proteins in an analysis, it has some serious limitations. First, the resolving power of 2-D gel electrophoresis is insufficient to separate the numerous proteins that may be important in the profile; i.e., 1,000 proteins compared to a possible 1,500,000. Second, the reproducibility of the technique is insufficient, making it difficult to detect differences in protein expression reflected in two different gels. Third, this technique is time-consuming (i.e., as much as several days) and labor-intensive. Fourth, various stains must be used to visualize the spots for digitization by a scanner or for excision for subsequent mass spectrometry (MS). These stains have variable sensitivities to protein structure and mass present in the spot and, therefore, are not reliably quantitative.

Because of the difficulties and limitations encountered when using 2-D gel electrophoresis for protein analysis, researchers are striving to develop alternative approaches. Recent noteworthy developments have been reported by several groups. An alternative to 2-D gel electrophoresis is coupling liquid-phase isoelectric focusing (IEF) to nonporous reversed phase high performance liquid chromatography (LC), which can be detected using MS. The analysis of breast epithelial cells in two selected ranges of pI values led to the detection of ˜110 proteins. Important differences in protein levels were observed between malignant and normal cell lines.

Others have developed 2-D LC systems coupled with MS for the analysis of complex protein mixtures. 2-D LC was performed in a so-called “biphasic” column containing reversed-phase packing followed by a strong cation exchanger. A 3-phase column, having an additional segment packed with reversed phase particles, enabled sample desalting on column. The 3-phase LC system provided a greater number of protein identifications than the “biphasic” column in analyzing a protein mixture from bovine brain.

Still others have reported 2-D liquid-phase separations using capillary IEF combined with capillary reversed-phase LC. A micro injector system provided the interface between the two separation dimensions. This system was evaluated on a Drosophila salivary gland soluble protein fraction and gave peak capacities as high as ˜1,800. An important advantage of this system is that the IEF step provides 50-100 fold sample concentration, which may help in the characterization of less-abundant proteins. While the analysis times for this system were an improvement over the several days often required for 2-D gel electrophoresis, the ˜8 h separation time is still slower than desired.

There is considerable interest in miniaturization of 2-D separation systems for protein and protein digest analysis. One group developed a microfluidic system that combined IEF with a series of denaturing capillary gel electrophoresis (CGE) channels. While promising initial results were obtained on a 3-protein mixture, this system required manual removal of buffer reservoirs and peeling off a polymer layer between the IEF and CGE step. Others developed a polymer microfluidic system for integrating IEF with CGE. However, the IEF step was carried out in a separate apparatus, and the small IEF gel strip had to be transferred manually to the microfluidic CGE separation platform. The separation of a mixture of 6 proteins was shown. Another group created a plastic microdevice with an IEF channel interfaced with 10 sieving matrix filled CGE channels. A 2-D analysis of 5 model proteins was done, and a maximum peak capacity of 1,700 was projected from the results. Nevertheless, the wide spacing (1 mm) and small number (10) of electrophoresis channels in this format limits performance and complicates detection.

One group recently developed a microchip system for 2-D separation of protein digests. In this micromachined platform, a micellar electrokinetic capillary chromatography separation provided the first dimension, while capillary zone electrophoresis (CZE) was the second separation dimension. Analyses of serum albumin, ovalbumin and hemoglobin tryptic digests were performed. While only 50-80 baseline-resolved fragments were observed in these separations, a maximum peak capacity of ˜4,000 peptide fragments was projected for this approach, based on the widths of the peaks in each of the separation dimensions. Importantly, the analysis time for this approach was very fast (10-15 min), illustrating one of the benefits of miniaturized separation methods.

These recent advances in multidimensional liquid-phase separations have addressed some of the shortcomings of conventional protein analysis technologies, such as speed, automatability, and convenient interfacing with MS detection. However, a critical need still exists for new technologies for the analysis of complex protein mixtures, especially platforms that integrate sample pretreatment and detection schemes with multidimensional separations.

Miniaturization in chemical separations with many of the same technologies used in integrated circuit (IC) or “chip” manufacture got its start over 25 years ago and has grown substantially since renewed interest was sparked by the development of planar microfabricated CE substrates in 1992. While miniaturization has the potential to revolutionize chemical separation methods as it did with integrated circuits, thus far the impact of microfabrication on separations has been modest.

While the initial microchip electrophoresis experiments were carried out exclusively on glass substrates, more recent efforts have also focused on the use of easily replicated and low-cost plastic or elastomeric materials. Poly(methylmethacrylate) (PMMA) microchannel systems, which have desirable optical and mechanical properties, were among the first polymeric substrates evaluated for microfluidic analyses. The ease of fabrication of microchannel systems in poly(dimethylsiloxane) (PDMS) made this material another appealing candidate substrate for microchip analytical platforms. A number of other polymeric microchip substrates have also been studied more recently. While typically providing simplified and low-cost device fabrication, polymeric substrates are disadvantageous in terms of compatibility with conventional Si processing methods that may require elevated temperatures, for example in thin-film deposition, which would hamper the direct integration of planar polymeric devices with some electronics, detection instrumentation, etc. Moreover, polymeric materials tend to be more compatible with stacked, rather than planar thin-film designs. To date, little success has been seen in fabricating functional microfluidic systems on silicon substrates.

The miniaturization of pumping methods for microfluidic systems has been pursued in several different ways, including the use of surface properties, pressure-actuated flexible membranes, or electroosmosis. The programmed control of surface temperature in thermocapillary pumping, or surface free energy using tailored self-assembled monolayers can enable liquid flow, but these approaches suffer from a significant level of device fabrication and surface modification complexity. Electrolysis-driven displacement of fluids and micromachined membranes has also been used for pumping. However, in the former approach, the electrolysis solution directly contacts the liquid being pumped, potentially causing contamination, while the latter method is complicated by the need to microfabricate a thin membrane for each pump.

Valves and micropumps that are driven by the actuation of flexible elastomeric membranes in controlled sequences have also been demonstrated. For these modules, the need for external pressure and vacuum sources to actuate the membranes makes the entire system difficult to miniaturize. Moreover, the use of PDMS membranes in direct contact with pumped fluids is problematic for LC, because PDMS acts as a hydrophobic stationary phase in chromatography.

Recent efforts to use electroosmosis to pump liquids in microchannels have also been reported. Issues not yet addressed with this form of pumping include challenges associated with reproducible etching of very shallow channel arrays and reliable thermal attachment of a cover plate to create large bundles of integrated microcapillaries to achieve suitable pressures. Hence, it would be an advantage over the state of the art to have pressure-driven micropumps that are easily integrated with both planar electronics and microfluidics.

One of the challenges with increasingly parallel microfluidic arrays is the two-dimensional nature of planar microchip systems. Some efforts have been directed at creating three-dimensional, layered microfluidic manifolds, but the initial attempts were quite cumbersome in terms of both fabrication and fluidics. More sophisticated recent work has utilized multiple-layer devices to create fluidic manifolds with increased liquid routing complexity. However, these systems utilize via holes through layers that can contribute to dead volume, and use materials such as PDMS that have poor stability in many solvents and reduced compatibility with planar Si micromachining processes. Thus, new approaches for creating complex sample handling manifolds for parallel analysis are still needed.

The systems described above demonstrate that there has been important progress in integration. Nevertheless, further improvements in terms of scaling down to microchannel dimensions in devices, and miniaturization and integration of detection are still needed. Moreover, these integrated microsystems could greatly enhance biochemical analysis. In summary, the full utility of miniaturization in separation-based chemical analysis will only be achieved when all components are integrated and reduced to a small size scale. Hence, what is needed is the development of fabrication techniques that will enable the creation of microfluidic systems which are compatible with conventional planar integrated circuit manufacturing processes.

### BRIEF SUMMARY OF THE INVENTION

The present invention is a system and method for performing rapid, automated and high peak capacity separations of complex protein mixtures through the combination of fluidic and electrical elements on an integrated circuit, utilizing planar thin-film micromachining for both fluidic and electrical components.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram showing the embodiment of design principles for silicon electronic circuits and microfluidic circuits.

FIGS. 2A, 2B, 2C, 2D are fabrication steps used to create microfluidic channels based on removal of a sacrificial core.

FIGS. 3A, 3B, 3C are SEM images of hollow waveguides formed by the removal of sacrificial (a) aluminum, (b) SU-8, and (c) reflowed photoresist.

FIG. 4 is a cross-sectional SEM of a hollow microchannel structure consisting of a single layer of silicon dioxide surrounding a hollow core, fabricated using aluminum as the sacrificial material.

FIG. 5A is a graph showing the length of aluminum etched versus etch time for microchannels fabricated using aluminum as the sacrificial material. The temperatures of the etchant and the width of the structure are indicated on the graph.

FIG. 5B is a graph showing the percentage of hollow microchannel intact after the etching process as a function of channel width for four different overcoating silicon dioxide thicknesses.

FIG. 6A shows top view optical micrograph of two crossing fluid channels built using sacrificial core etching, and 6B is a close-up SEM image of the crossing point for the channels.

FIG. 7A shows SEM view of the intersecting channels that form the key element of an electrophoresis separation system.

FIG. 7B is an SEM view of the cross section of a channel.

FIG. 8 is a graph showing electrophoretic separation of an amino acid mixture made using a hollow channel T structure on a quartz substrate.

FIG. 9 is a photograph of four PMMA reservoirs attached to a thin film microfluidic system on a substrate.

FIG. 10 is an illustration of an on-chip electroosmotic pumping device using closed channels formed from sacrificial etching.

FIG. 11A is a top view optical micrograph of the critical part of an electroosmotic pumping system built using sacrificial core etching.

FIG. 11B is an SEM cross-section picture of the channels.

FIG. 12 is a graph of liquid linear velocity and flow rate as a function of applied voltage in an electroosmotic pump.

FIG. 13A is an SEM image of an ARROW waveguide with a 3.5×10 μm hollow core and polarization of incident laser indicated.

FIG. 13B is an optical mode profile measured using a CCD camera. The inset shows a false color representation of the light intensity of the mode.

FIG. 13C is a comparison between experiment (symbols) and theory (lines) of transverse and lateral mode cross sections.

FIG. 14A is a block diagram of a fluorescence setup.

FIG. 14B is a graph of a fluorescence spectrum. Inset: Fluorescence emitted at end facet of ARROW waveguide.

FIG. 15 is a graph showing fluorescence power vs. dye concentration.

FIG. 16A is an illustration indicating a hollow ARROW waveguide being intersected by a solid-core waveguide.

FIG. 16B is an SEM image of fabricated waveguide intersections.

FIG. 17 is a schematic of a proposed complex microfluidic system for protein analysis. This system is designed to fit on a 3 cm×3 cm chip.

FIG. 18 is an alternative schematic to FIG. 17 for a proposed complex microfluidic system for protein analysis. This system is designed to fit on a 3 cm×3 cm chip.

FIG. 19 is a schematic diagram of a device layout for testing the integration of sample pretreatment/concentration/desorption with CGE in a planar format.

FIG. 20 is a schematic diagram of a device layout for testing integrated capillary IEF with CGE in a planar format.

FIG. 21 is a zoom view of the interface between the IEF channel and CGE channels.

FIG. 22 is a schematic diagram of a device layout for coupling CGE of proteins with enzymatic digestion and peptide CZE.

FIG. 23 is a schematic diagram of a microfabricated system that integrates planar optical detection based on liquid waveguides.

FIG. 24 is a schematic diagram of a microfabricated system to demonstrate the integration of all components developed for the analysis of proteins.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

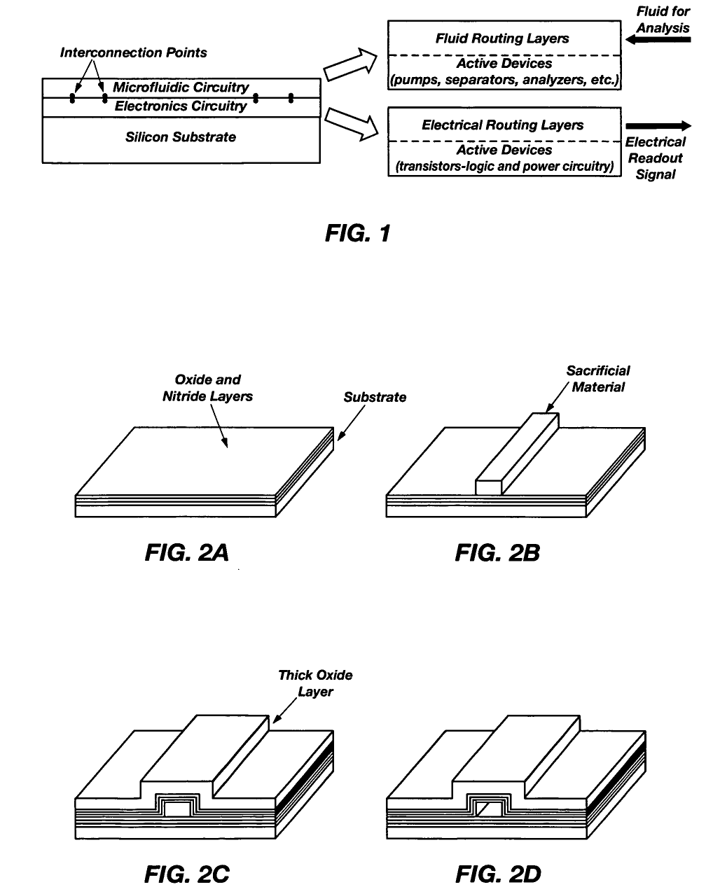

The present invention is a system and method for integrating microfluidics directly onto electronic systems, thereby making it possible that logic and electric power elements can be built into a microfluidic analysis system. FIG. 1 illustrates the fundamental design concepts of the present invention.

FIG. 1 is provided as an illustration of a cross section of a substrate showing how microfluidics are combined on the same substrate with microelectronics using thin-film microfabrication techniques. Using flat silicon substrates 10, electronic circuitry 12 is made in standard silicon foundries, leaving a flat surface of silica covering active components 14 and routing layers 16. Over these, active microfluidic circuitry 18 in the form of microfluidic devices (preferably using silica-based materials) 20 and silica-based fluidic routing layers 22 are made. Between the microfluidics 18 and electronics 12 layers, metal interconnects 24 relay information and power signals where needed.

One important advantage of using planar, silica-based microfabrication processes is the existing fabrication tools. This point is fundamental to the present invention. The microelectronics industry has spent tens of billions of dollars developing integrated circuit (IC) fabrication technology, making it some of the most advanced and precise equipment in the world. These available tools make research and development much easier, and allow compatible processes to be done cheaply and on a large scale at silicon foundries around the globe.

Another advantage of using IC fabrication technology for the present invention relates to the methodology that has been developed. Much of the burden of complex electronic circuit design in the microelectronics industry has been shifted to specially designed computer aided drafting (CAD) programs. These programs contain what will be termed a “toolbox” to help the designer. In the toolbox are designs for hundreds of active devices and functional groups. For instance, if a common logic element or voltage converter is needed in a design, a user can simply select from the toolbox and drop it into the design. CAD programs also include automatic wire routing routines, design rules for placement and size requirements, and performance models that provide very accurate predictions of how a circuit will work before it is ever made in silicon. CAD tools allow teams of designers to work on the same large circuit divided into functional groups. Successful design using CAD tools relies on very robust fabrication processes and devices. A transistor must look and act the same anywhere on a chip.

In the present invention, the design of complex microfluidic circuitry can follow much of the same approaches used to do CAD layout in microelectronics. In fact many of the existing CAD programs can be adapted to allow for user-specified devices and design rules. The first step in building a microfluidics toolbox is identifying robust designs for active microfluidic components including fluid pumps, separation devices, and detectors. The second step is identifying design rules for spacing and widths of fluid channels for routing and connecting, including branching elements. Just like in microelectronics, it is very important that active devices and connections have the same performance no matter where they are placed in an on-chip network. When reproducible designs can be fabricated and well characterized, performance models can then be created to analyze a microfluidic circuit design before it is ever fabricated.

A variety of designs and mechanisms have been created for the active components of a microfluidic system. Also considered was how robust and reproducible these active devices could be made so as to fit into a CAD toolbox.

For example, pumping based on multiple layers of elastomeric membranes is not amenable to the flat, planar micromachined construct of the present invention. Of those pumping systems that are compatible with planar Microsystems technology, some require considerable levels of fabrication complexity (membrane-based actuation) or significant post-fabrication surface modification (surface property-based methods). Accounting for these considerations, electroosmotic pumping is the best-suited approach for this toolbox of the present invention because of its fabrication simplicity and ease of integration in a planar, flat format.

For networks and separators, the use of stacked, layered systems with through-holes is poorly suited to the flat, planar constraint of the toolbox. Moreover, while conventional, single-layer approaches provide some level of complexity, they are limited by the inability to provide complex fluidic routing where channels can cross over one another without interference. Thus, the microfluidic network created for this toolbox must improve over existing techniques to allow complex, crossing arrays of channels within a planar system.

Regarding detectors, it is noted that the most sensitive method for detecting the presence of a biological species of interest is to attach a fluorescent label and measure it optically using a microscope. For a highly complex on-chip fluidic test platform with many test points, using this kind of optical detection system is unreasonable. In order to have very high sensitivity optical detection for an on-chip system, it would be ideal to efficiently route light signals across a chip from a point of detection to an on- or off-chip detector away from a sample. This requires the use of optical waveguides.

Another method of detection that fits in with the planar design philosophy of the present invention is the direct electrical measurement of biological species in a microfluidic channel. This can be done by attaching electrodes across a channel and monitoring the impedance of a fluid as it flows by the electrodes. Biological material passing through the detection window will be indicated by a change in impedance. These measurements can be very sensitive and are aided by the small geometry of microfluidic channels.

Having shown what the present invention is intended to accomplish through the use of a toolbox, a typical fabrication process of the present invention is now described in detail. One of the keys to achieving a truly integrated on-chip sensor system was the development of a novel fabrication method of the present invention that can be used on a variety of surfaces (i.e., semiconductors, insulators, polymers, ceramics, metals and glasses). This fabrication method must enable the creation of hollow channels for fluid manipulation, waveguides for routing optical detection information, and metallic lines and pads for routing electrical signals. In the interest of economics, it is also an important aspect of the present invention that any new microfabrication techniques not stray too far from standard procedures used in the microelectronics industry.

The first step of the present invention is to select a suitable substrate material. So as not to stray from existing techniques for creating integrated circuits, a silicon substrate will be used in the following example. Nevertheless, it should be understood that any suitable substrate material known to those skilled in the art of integrated circuit fabrication can also be used in the present invention. As explained, these substrate materials include semiconductors, insulators, polymers, ceramics, metals and glasses.

The next step is to create hollow tubes by surrounding a sacrificial core with silicon dioxide or silicon nitride. The sacrificial core is then removed with etching.

This fabrication process of the present invention is depicted in FIGS. 2A, 2B, 2C and 2D, and relies on two well-known microelectronics-based processes. The first process is the chemical removal of a material applied to a substrate, and the second is chemical vapor deposition (CVD) of silicon-based thin films.

In one embodiment of the present invention, a substrate 30 is coated with silicon dioxide and/or nitride layers 32 using plasma enhanced chemical vapor deposition (PECVD). This process takes place at approximately 250° C. In development of the present invention, silicon, quartz, and glass substrates have been used. Tolerance to the temperatures used in the vapor deposition process limits the materials that can be used for the substrate. In another embodiment, it is suggested that other PECVD compatible solid films such as amorphous silicon can also be used. Likewise, evaporated dielectric thin films like alumina and silicon monoxide can be used in other embodiments.

Next, a thin layer of sacrificial material 34 is then deposited and defined into a thin line using photolithography and etching techniques.

It is observed that a variety of sacrificial materials may be used, including photosensitive polymers and metals. What is important is that the sacrificial material be capable of being removed through some process, such as acid etching, without damaging the underlying substrate or other layers of materials on the substrate, if any.

An overcoat layer of PECVD oxide 36 or nitride is then grown which covers the sacrificial material 34. The conformal nature of this process is important to ensure that the sacrificial material 34 is completely enclosed.

The final step of the process is to expose the sacrificial material 34 to an etch from either end of the channel 38. Upon completion of the acid etch, the result is a hollow tube 40 with walls composed of either silicon dioxide or silicon nitride.

The process above describes the creation of a single, straight, hollow tube. However, one of the important advantages of the present invention is the ability to create tubes that can bend, tubes that can cross over other tubes without being in communication, tubes that can intersect and join with other tubes, and the creation of multiple parallel tubes, to name just a few. Thus, like a complex transistor circuit having multiple electrical connections and layers all meeting in the same location in a very precise manner, the present invention is able to create complex interactions and intersections of tubes for the flow of fluids.

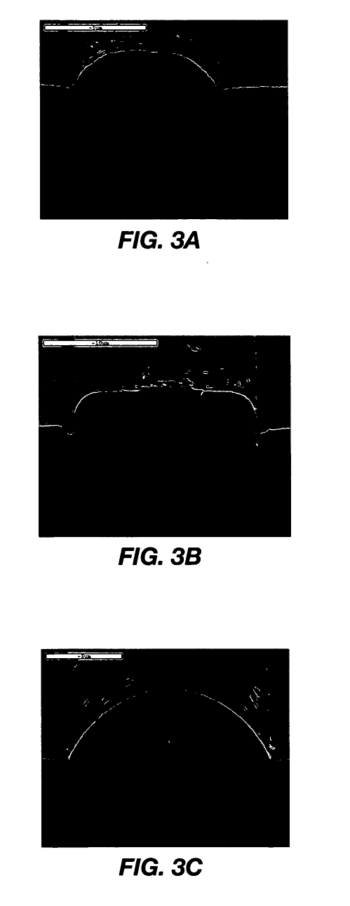

A number of sacrificial materials have been investigated in the context of the fabrication process described above. These sacrificial materials include aluminum, SU8 (a photosensitive epoxy), and photoresist. Aluminum is most quickly removed using a nitric and hydrochloric acid etching solution while SU8 and photoresist are removed using a sulfuric acid and hydrogen peroxide solution. The different sacrificial materials result in different shaped hollow core cross sections as illustrated in FIGS. 3A, 3B, 3C, thus providing the advantage of additional flexibility when designing microfluidic devices. The important factors in choosing the sacrificial materials are the shape of the resulting channel, and the ease with which the sacrificial material can be removed.

The hollow channels 40, 42, 44 shown in FIGS. 3A, 3B and 3C depict openings that are very small, down to approximately 3 μm across. These diameters are more than an order of magnitude smaller than typical on-chip fluid channels produced by other prior art methods.

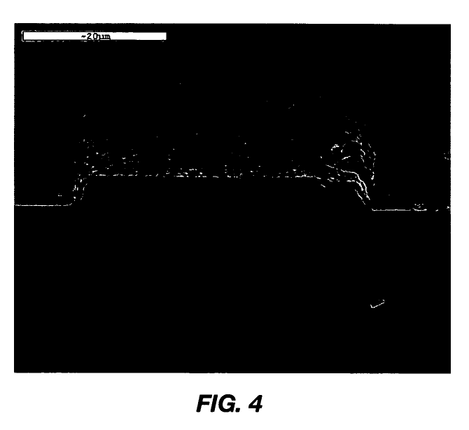

The process can also be used to produce a much wider channel 46 as shown in FIG. 4. This image shows a cross section of a hollow structure 50 μm wide with walls only 1 μm thick. The hollow microchannel structure 46 consists of a single layer of silicon dioxide 48 surrounding the hollow core, fabricated using aluminum as the sacrificial material. The silicon dioxide layer is 1.0 μm thick and the hollow core is 3.0 μm thick.

In order for structures made using the new planar, thin-film technology of the present invention to be useful for fluid and light guiding, the channels must have smooth inner walls, be of reasonable length, and mechanically strong. The first criterion is important to prevent optical scatter or interruptions in fluid flow and is met by the conformal CVD coating as evident in SEM micrographs of the channel structures. Experiments to determine ultimate channel length and strength were conducted and were compared to physical models.

Because hollow structures are formed through the chemical etching of a sacrificial layer, the ultimate channel length and fabrication time will be dependent on this chemical process. Etch times were investigated for aluminum sacrificial cores 700 nm thick patterned on silicon. Core width varied between 10 and 300 μm. A single layer of silicon dioxide 3.0 μm thick was deposited over the aluminum, the silicon substrate was cleaved, and then the samples were placed in an aqua regia (3:1 mixture of hydrochloric and nitric acid) solution. Samples were periodically removed from the acid solution, and the amount of aluminum that was etched was measured using an optical microscope.

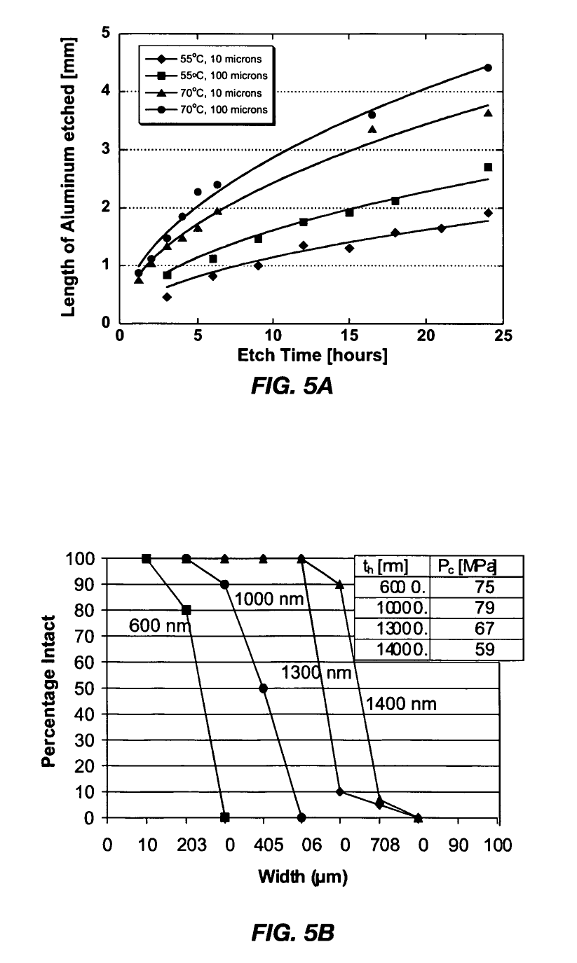

FIG. 5A shows a graph of the total length of aluminum etched versus time in the etchant for tubes that are 10 and 100 μm wide and at solution temperatures of 55° C. and 70° C. Because the structures were cleaved twice, aluminum was removed from both ends of the structure simultaneously during etching. The numbers in the graph represent the total length of aluminum etched from both sides. The etch length follows the equation:
l(t)≈\sqrt{2kₙDcₒt} EQUATION 1
where l(t) is the length of the channel etched in a given time, kₙ is a constant relating to the geometry of the channel, D is the diffusion coefficient for etchant through the channel, and cₒ is a constant relating the concentration of the most critical component of the etch solution. Curves with a square root dependence of etched distance versus time were fit to each of the data sets in FIG. 5A, indicating the diffusion limited nature of the etch mechanism. The graph indicates that the speed of etching increases with temperature of the etching, and wider channels etch faster than narrower ones (due to a change in the constant kₙ related to channel geometry). Under the fastest etch conditions reported in FIG. 5A, a nearly 5 mm structure can be etched in 24 hours, which is a manageable fabrication time for most devices. Total etch times can be reduced by raising the temperature of the etch solution or increasing the nitric acid concentration (increasing the constant cₒ). Although not shown in the graph, a 2:1 hydrochloric to nitric acid mix at 85° C. can clear a 10 mm channel in less than 24 hours.

In order to determine the ultimate mechanical strength of the hollow structures, a finite-element analysis was done using a commercially available software package (ANSYS 6.0). To provide the necessary stress and strain constants to the software, a set of experiments was also done. The results of the model indicate that the critical failure pressure for a hollow channel can be given by the simple expression:

$${P}_{c} = 2 {{S}_{t} ( \frac{{t}_{h}}{w} )}^{2} \qquad EQUATION 2$$

where Sₜ is the tensile strength of the overcoat material, tₕ is the thickness of the overcoat layer, and w is the width of the channel. This simple equation reveals the functional dependence of the pressure on the width and thickness, and agrees within 10% of the values calculated using the finite-element simulation when tₕ/w<1/10. Tests were done on real structures by varying their core width and overcoat thickness to confirm this expression. Results are shown in FIG. 5B for channels 2 cm long, indicating that for all cases, the channels were able to withstand an internal pressure of 0.70 MPa±16% before failure.

Another aspect of the present invention with regards to the creation of integrated microfluidic devices is the ability to generate networks of fluid channels that can route liquids over the surface of a chip much like dense electrical signals are routed in integrated circuits. This requires the creation of cross-over elements and T-branches just like in macro-plumbing.

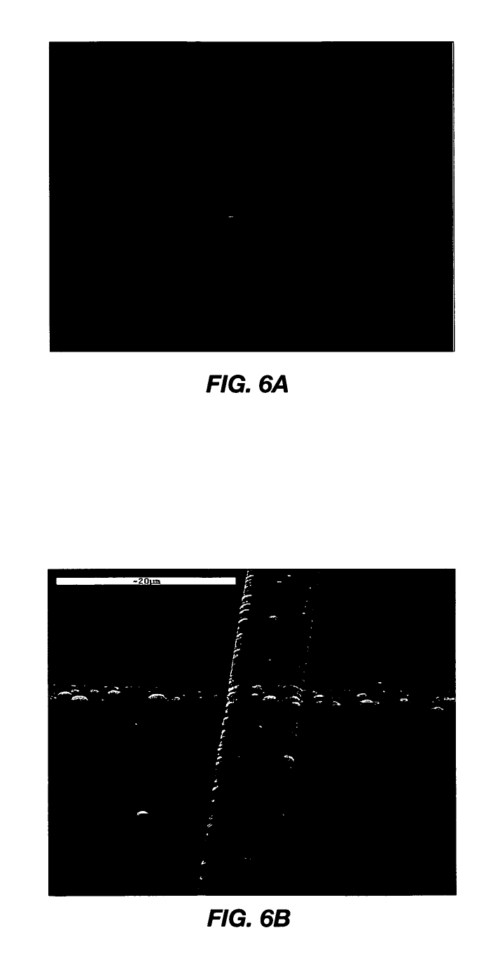

The first of these structures is shown in FIG. 6A. FIG. 6A is a microscope picture of a hollow channel 50 passing over the top of another hollow channel 52, which was made by completing the process for creating a single hollow tube, and then repeating the process for a tube laid out perpendicular to the first one. The sacrificial materials for both cores were removed simultaneously. To test the integrity of the crossover point, fluid was placed in both channels 50, 52 and electrophoretic flow was initiated. There was no detectable leakage or cross-talk between the channels.

FIG. 6B is a close-up of the crossover point where the channels 50, 52 cross.

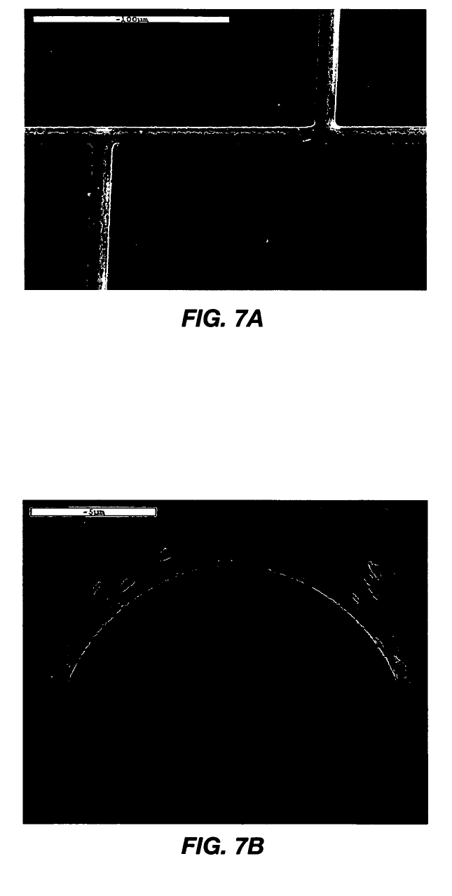

Branching structures were also created using the present invention by applying a sacrificial core and photodefining it into a desired branching geometry. FIG. 7A shows a top view electron micrograph of these channel structures 60. The core used in this case was a combination of aluminum and photoresist. This hybrid core structure takes advantage of the fast etch rate achievable when removing aluminum and the smooth, half dome geometry possible when using photoresist and reflowing it at a high temperature. A cross-section of these channels 60 is shown in FIG. 7B.

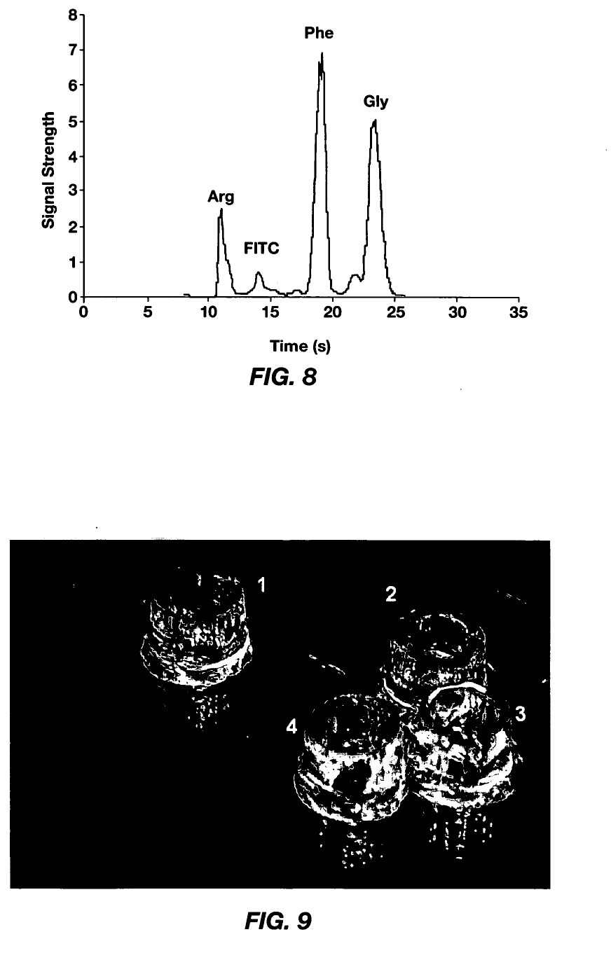

To demonstrate their utility and robustness, the intersecting hollow channels shown in FIG. 7A were used as the critical element of an electrophoresis separation device. These structures were fabricated on a quartz substrate with a separation channel extending away from the intersection region. Three amino acids, arginine, phenylalanine, and glycine, were labeled by reacting fluorescein 5-isothiocyanate (FITC) with their respective amine groups. After labeling, the amino acids were diluted to 500 nM in 100 mM carbonate buffer, pH 9.2. Pipetting 10 μL of the buffer solution into the reservoirs caused the channels to be filled by capillary action. For separation, reservoirs 1, 2 and 3 were filled with the buffer solution and reservoir 4 was filled with 10 μL of the prepared sample. To move the sample into the injector, reservoirs 1, 3 and 4 were electrically grounded, and −600 V was applied to reservoir 2. The loaded sample was separated by grounding reservoir 3, applying −600 V to reservoirs 2 and 4, and applying −750 V to reservoir 1. Confocally filtered laser-induced fluorescence detection was accomplished using an Ar ion laser for excitation and a photomultiplier tube detector. Fluorescence was probed approximately 0.65 cm away from the junction region shown in FIG. 7A. The separation was completed in under 30 s (FIG. 8).

Interfacing microfluidic devices to external fluid sources and reservoirs is another important consideration for an integrated system because every analytical system must interact with the macro world. A number of schemes have already been investigated that would provide large fluid reservoirs on chip and be compatible with hollow core devices.

The most successful procedure to date involves laser cutting cylinders 70 in PMMA and directly attaching the cylinders to the substrate by heating to 200° C. The bottom of the cylinder 70 melts and attaches conformally to the substrate, sealing around the hollow channels and forming a small reservoir that holds 10 μL. Pipettes or syringe needles can then be used to fill or extract liquids. FIG. 9 shows four of these reservoirs 70 attached to a quartz substrate 72 at the ends of channels used for electrophoretic separations.

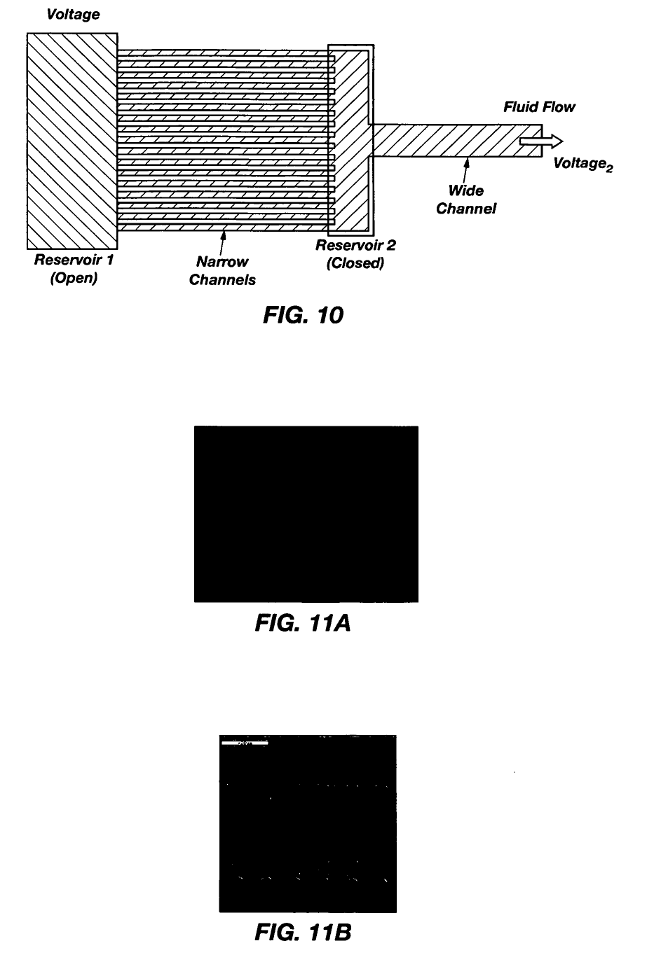

A major aspect of microfluidics is the manipulation of fluid flows in small on-chip channels. One of the most attractive ways of doing this is by using electrical forces (electroosmotic flow). An electroosmotic pumping device can be built by directing the fluid flow generated from a large number of small diameter channels from one reservoir into another. The design of such a pump is illustrated in FIG. 10. Voltages 80, 82 are applied at both ends of the device, and the generated electric field produces fluid flow 90 in the small diameter channels 84. Pressure in Reservoir 2 86 then pushes fluid into the larger diameter channel 88 to the right.

Implementing an electroosmotic pump with enclosed channels is implemented as follows. A sacrificial core was applied and then photodefined into the pump geometry. Conformal PECVD oxide was grown over the core, and then the sacrificial layers were removed. Pumps were made on silicon, glass, and quartz substrates using aluminum as the sacrificial material.

FIG. 11A shows a top view photo of the critical section of an electroosmotic pump taken with an optical microscope. The width of the small channels 100 on the left of the photograph was approximately 3 μm, while the width of the larger channel 102 shown on the right was 25 μm. FIG. 11B shows a cross section of the channels 100 taken using an SEM.

A pump fabricated on an SiO₂ substrate with 100 channels (1 μm in width and depth each) feeding into a single 40 μm wide channel was evaluated. The pump was initially filled with a pH 9.5 carbonate buffer solution. A reservoir surrounding the small channels was filled with carbonate buffer containing 9.1 ppm rhodamine B. Voltage was applied to the pump reservoir, and the pooled buffer at the opening of the large channel was grounded, driving the electroosmotic flow toward ground. The movement of rhodamine B through the large channel was followed using a CCD to image the laser induced fluorescence signal from the compound. The 514 nm line from an Ar ion laser directed into an inverted microscope was used to excite the fluorescence. CCD images were taken at a rate of 50 Hz, and included 15.2 mm of the large channel. Flow rates were determined by the time span between the initial appearance of rhodamine B and complete filling of the imaged channel.

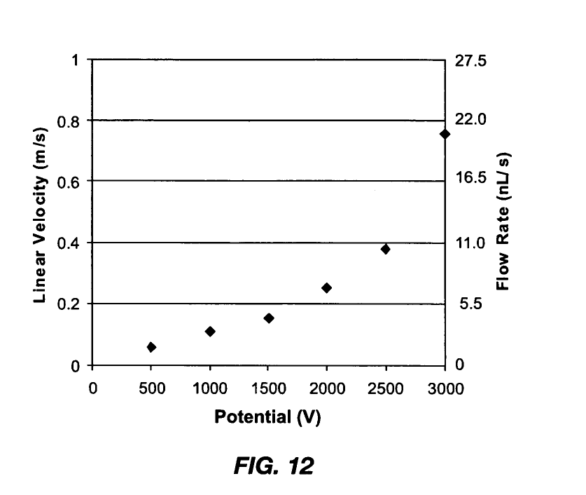

FIG. 12 shows a plot of liquid linear velocity and flow rate in the large channel as a function of voltage applied. The characterized pump represents a minimum attainable geometry for the narrow channels. Flow rates will increase with increase in number of total channels and/or channel diameter.

Waveguides were mentioned previously as being an important element of the microfluidic components. In the present invention, optical detection on microfluidic platforms will be played by ARROW waveguides. These structures enable light to be routed through liquid channels on the surface of a chip from optical sources to points of detection, and from points of detection to on-chip and off-chip optical detectors. ARROW construction requires the deposition of several alternating layers of silicon dioxide and silicon nitride of thicknesses specific to the wavelength of light to be guided. These layers surround the sacrificial core material in all dimensions.

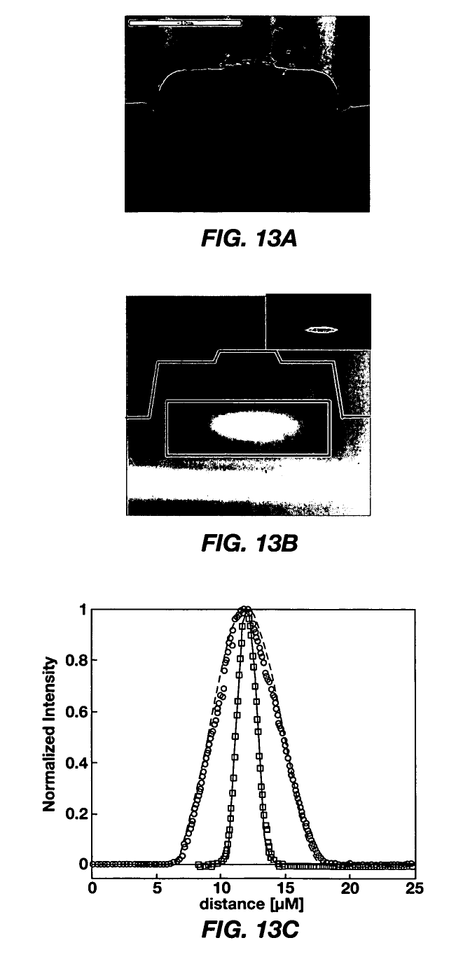

A cross sectional view of an ARROW is shown in FIG. 13A. Evident in the SEM are the alternating layers of oxide and nitride that have been etched to appear as light and dark layers in the picture. Optical tests on these waveguides are shown in FIG. 13B in which the structure has been filled with ethylene glycol and illuminated with a 785 nm wavelength laser on one side of a cleaved facet while the other side was imaged as shown. The geometry of the waveguide is outlined to better indicate the location of the propagating optical signal in relation to the top and side walls. Ethylene glycol was used as the liquid in this test to reduce the amount of evaporation and to allow time to perform measurements.

FIG. 13C shows the extent of the measured optical mode profile compared to theoretical computer models. The excellent agreement indicates that we can accurately design and build ARROWs given any liquid core and any light wavelength. Optical loss for these structures, the most important figure of merit for waveguides, was measured to be close to 0.1 cm⁻¹. This is well within the required performance range for on-chip devices.

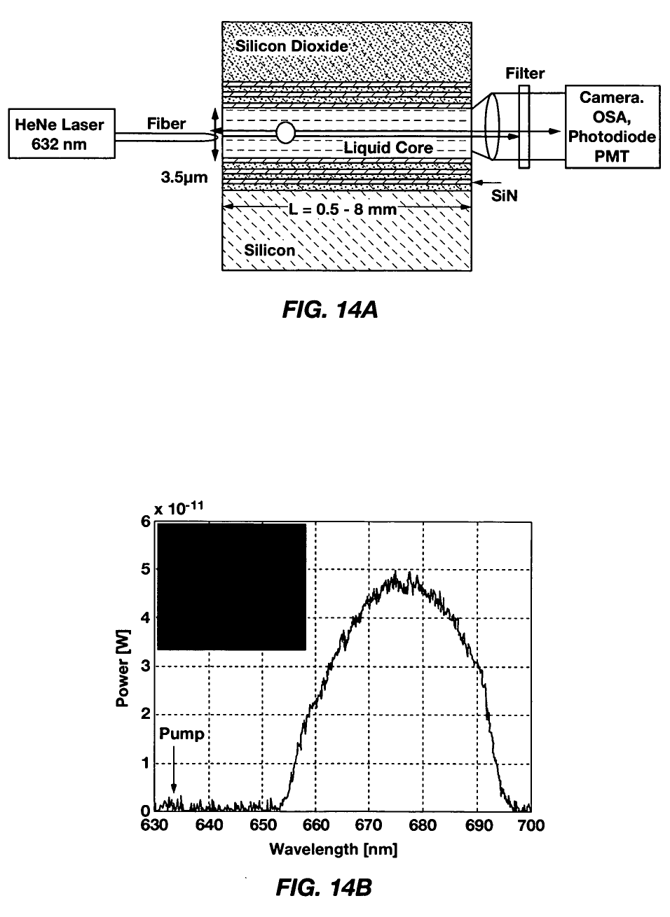

Because fluorescence detection is one of the most sensitive measurement techniques for biological samples, ARROW waveguides were also filled with fluorophore containing liquids as illustrated in FIG. 14A. The structures were specifically designed to guide the fluorescence signal from a fluorophore pumped at 632 nm. The fluorescence spectrum from the waveguide is shown in FIG. 14B.

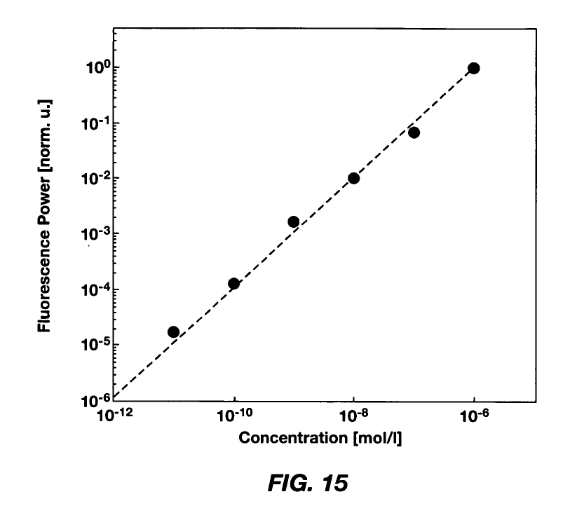

This same setup was used to measure detection limits for fluorescence signals. The results are shown in FIG. 15, indicating detection down to several pmol/L (corresponding to 500 dye molecules in the waveguide). These limits of detection will be improved significantly by using a better detector and filter setup.

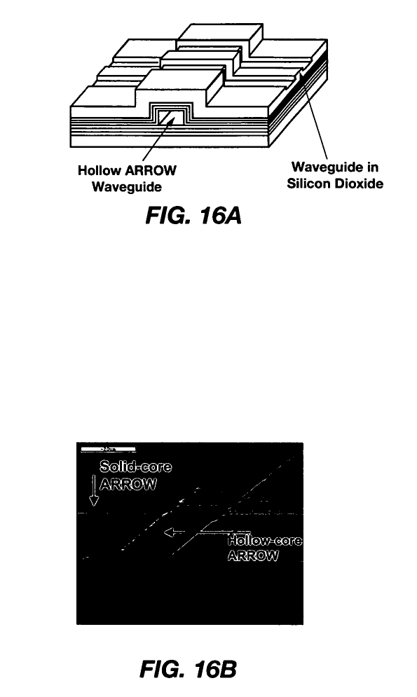

It is also desirable to integrate liquid waveguides with solid-core waveguides for routing optical pump or measurement signals. One application would be to illuminate only a very small volume of liquid inside a waveguide (femtoliters, fL) for detecting single molecules by intersecting a solid core waveguide with a liquid one as illustrated in FIG. 16A.

Taking advantage of the existing oxide and nitride layers used in constructing ARROW waveguides, the integrated structure is created as shown in FIG. 16B. To test the collection efficiency of this intersection, the hollow waveguide was filled with an ethylene glycol solution containing Alexa 647, the same dye used in the previous experiments, and a 632 nm laser illuminated the solid-core ARROW. The total amount of liquid illuminated in the hollow core was 59 fL. Using a series of filters, it was possible to detect a fluorescence signal from the dye transmitted out the hollow-core waveguide. Microscale impedance measurements are another application of the present invention. The most sensitive detection methods for biological molecules and agents are currently based on fluorescent tags. This mechanism requires the necessary optical sources and detectors, and the introduction of a relevant fluorophore that can attach to a molecule of interest. It would be desirable for many reasons to have a sensitive method of detection based upon electric measurements, including ease of integration. One potential electrical characteristic to measure would be impedance or, inversely, conductivity. Differences in material impedances present some of the largest contrasts in our natural world (i.e., electron flux in glass vs. metal). Biologists have known for many years that different types of tissues have different impedances and have used this information to classify samples and produce images on the mesoscale.

The use of impedance/conductivity measurements on the microscale has also begun to emerge in high resolution scanning systems as well as in fluid channels. Especially relevant to measuring biological agents of less than 1 μm in length has been recent work the inventors have done involving a high resolution scanning system and specially designed microprobes. To this point, probes with dimensions of approximately 10 μm have been able to produce images with resolution of approximately 10 μm. The goal is to produce probes with dimensions of less than 1 μm using micromachining to generate high-resolution images of single cells. The same techniques used to produce impedance contrast information in this scanning system can be applied to microfluidic channels.

Packaging options for microfluidic components based on planar, thin film technology are almost limitless, and each depends on the application of interest. In fact, most fluidic manipulations can be addressed by this technology. The previous sections have addressed the development of a variety of components that could comprise a microfluidic chip. This next discussion describes the design of a microfluidic device that integrates the components necessary to address a very complex application.

The area of proteomics is extremely challenging, requiring complex multidimensional approaches to separate and identify the vast number of proteins in biological samples, especially those that are present at trace levels. The planar microfluidic technology taught by the present invention allows the integration of many protein manipulation steps in a microdevice for separation and identification of complex protein samples at resolution and speed never before achieved.

As an example of the power and versatility of planar, thin film microfluidics for biomedical applications, the present invention makes possible the fabrication of a microfluidic chip that integrates the steps of extraction, concentration, separation, and identification of complex protein samples.

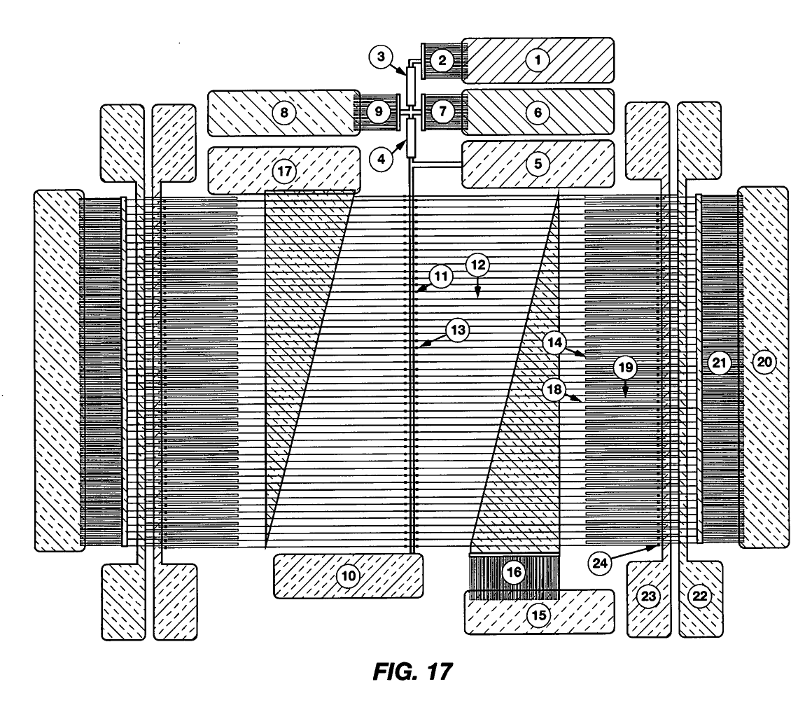

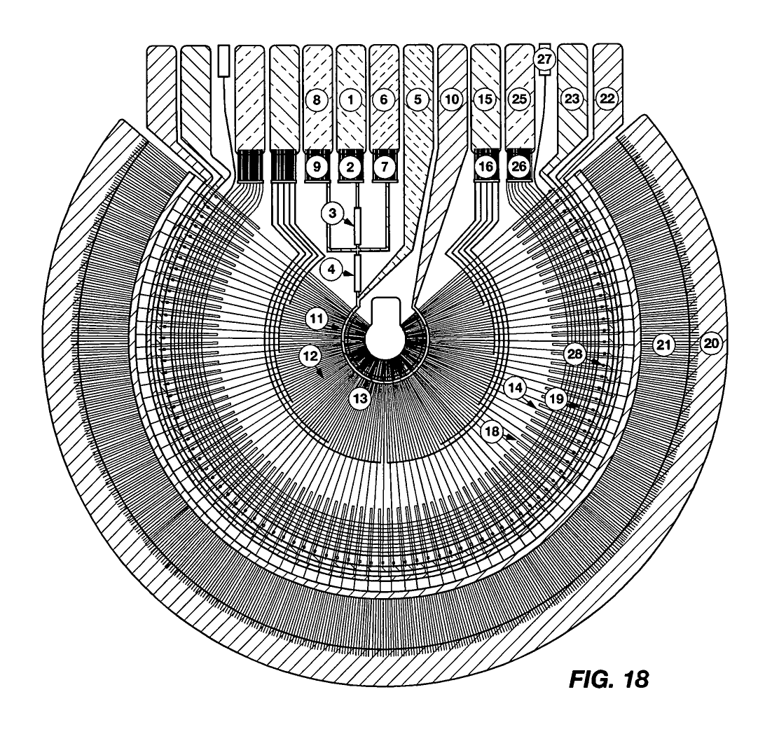

Two possible configurations of the overall schematic of the microfluidic layout are shown in FIGS. 17 and 18. Each microfluidic system is designed to fit on a 3 cm×3 cm chip. Each analytical scheme begins by moving a sample from reservoir 1 through a multichannel electroosmotic pump 2 and through a porous monolith 3 that has bonded affinity groups selective for the abundant proteins, such as albumin. This step removes high concentration proteins so that the less abundant ones can be concentrated and detected more easily. These non-bound proteins are introduced into a second porous monolith 4 containing a different selective affinity ligand or a nonselective solid-phase extraction (SPE) binder for proteins, where all of the remaining proteins are concentrated. Sampling and trapping can continue until sufficient protein has accumulated in monolith 4 for further separation and detection.

This two-step sample clean-up and concentration process is effected by applying voltage between sample reservoir 1 and a waste reservoir 5. Termination of sample loading and further clean-up of the bound protein sample can be accomplished by switching the voltage from sample reservoir 1 to a rinse reservoir 6 so that current flows from rinse reservoir 6 (activating electroosmotic pump 7) through monolith 4, rinsing off non-bound species to waste reservoir 5.

The protein sample is desorbed from monolith 4 by switching the voltage from rinse reservoir 6 to a desorber reservoir 8 and from waste reservoir 5 to another waste reservoir 10, allowing electroosmotic pump 9 to move desorber buffer through monolith 4, displacing the bound proteins from the monolith. The desorber solution will flow into waste reservoir 5 by pressure flow because channel 11 between reservoir 5 and waste reservoir 10 is filled with isoelectric focusing gel. As the desorbed proteins enter the T-junction of waste reservoir 5, they are drawn into the isoelectric focusing channel 11 by electrophoresis.

The isoelectric focusing channel 11 contains gel bonded immobilines that create a pH gradient along the channel to focus and concentrate proteins according to their pI values. After the proteins are focused, they are driven into numerous orthogonal gel electrophoresis channels 12 by switching the voltage from desorber reservoir 8 to buffer reservoir 15 and from waste reservoir 10 to buffer reservoir 20. Proteins will be separated according to size and charge by gel electrophoresis in channels 12. In order to maintain constant pH at the top of the CGE channels, buffer 15 will be continuously pumped by electroosmotic pump 16 through intersection point 13 into waste reservoir 17. At the end of each channel 12, the proteins will be introduced into a monolith 14 containing a bonded protein digestion enzyme. The peptides that are formed in the monolith will move from the monolith immediately into a peptide concentrating area 18 (separated merely by a conductive membrane from flowing buffer in contact with the voltage source at reservoir 20) before being released for CZE separation in channels 19. Buffer 20 will be continuously pumped by electroosmotic pump 21 through intersection points 14 into common waste reservoir 22 in order to maintain constant pH in the intersection points 14. Periodically, during concentration of peptides in the peptide concentrating area, voltage will be momentarily switched from reservoir 15 to reservoir 23 to release the concentrated peptides and initiate fast CZE separation in channels 19. During the CZE separation in channels 19, migration in the CGE channels will be stopped. By switching the voltage back and forth between reservoirs 15 and 23, proteins that migrate into the digestion monolith will be fragmented, trapped, and subsequently separated by CZE to produce peptide profiles that are characteristic of each of the proteins in the sample. These peptide digest profiles will be used in a similar way that mass spectra are used to identify compounds. Different bonded digestion enzymes can be used in different microfluidic systems to provide complementary fragmentation profiles for more definitive identification of the proteins.

Two different detection systems can be used: electrical impedance measurement of native peptides (shown schematically in FIG. 17) and fluorescence detection of tagged peptides (shown schematically in FIG. 18). For electrical impedance measurement, electrodes 24 will be located just before waste reservoir 23. For fluorescence detection, a fluorescent tag reagent in reservoir 25 will be added to the separated peptides at the end of the CZE channels 19 using electroosmotic pump 26 just before the laser 27 illuminated ARROW waveguide excitation junctions. Fluorescence will be detected at the ends of the ARROW/CZE channels 19 using off-chip solid state detectors.

Having described at least one embodiment of the present invention, some observations are useful. For example, at least two layers of fluid routing channels will need to be constructed for most applications. This is illustrated in FIGS. 17 and 18; channels carrying buffer solution to the junctions of the IEF and CGE channels must cross over the CGE channels themselves. Hundreds of crossover points on a chip will likely be necessary. It is another aspect of the present invention that vias will have to be made at some crossover points so that channels made in separate deposition steps can be fluidically connected.

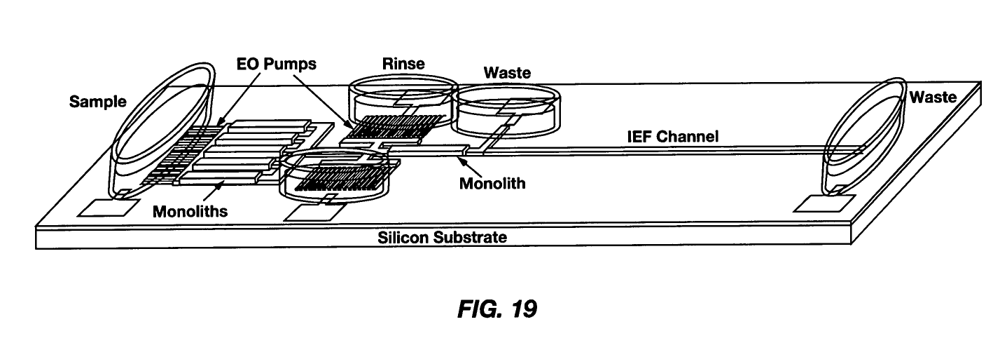

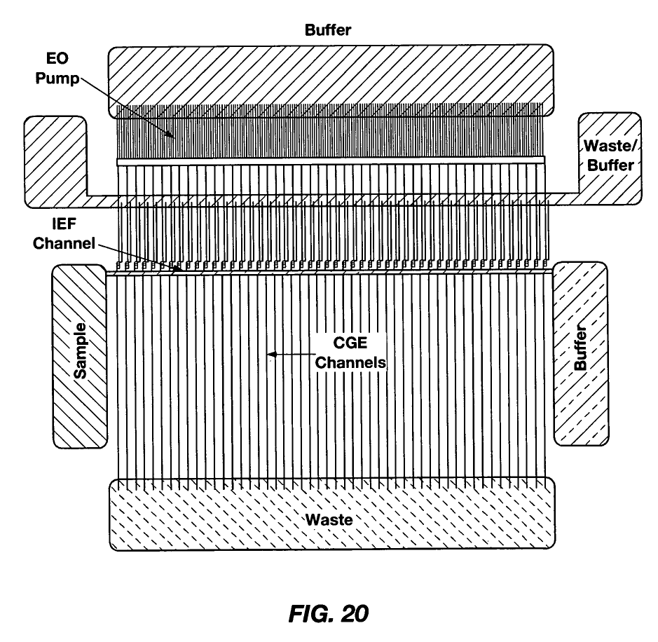

It is another aspect of the present invention that it can also be used to integrate sample pretreatment and concentration processes. A microfluidic subsystem for sample clean-up and concentration will be developed as shown in FIG. 19. The main purpose of this subsystem is to isolate the primary proteins of interest away from highly concentrated proteins such as albumin and IgG, and other interfering compound types that might be present in biological samples. A few abundant proteins can occupy over 80% of the sample, so some pretreatment is necessary to remove these abundant components before introducing the sample onto the microfluidic system.

Another subsystem that can be created using the teachings of the present invention is an integrated 2-D separation, consisting of IEF followed by CGE. Development of this package will be critical to achieving high peak capacity separations. A device layout for this subsystem is illustrated schematically in FIG. 20. Protein mixtures are loaded into a sample reservoir, and IEF occurs when a potential is applied between the sample and buffer reservoirs, across the gel-filled IEF channel containing immobilines to supply a pH gradient. In the applied field, proteins will be focused into concentrated bands within the IEF channel according to pl values. After focusing is complete, bands will be injected into the array of CGE channels by applying a potential between the buffer and waste reservoirs addressing the ends of the CGE columns. If needed, an EO pump can be designed to flush fresh buffer through the microchannel loops that address the ends of the CGE channels.

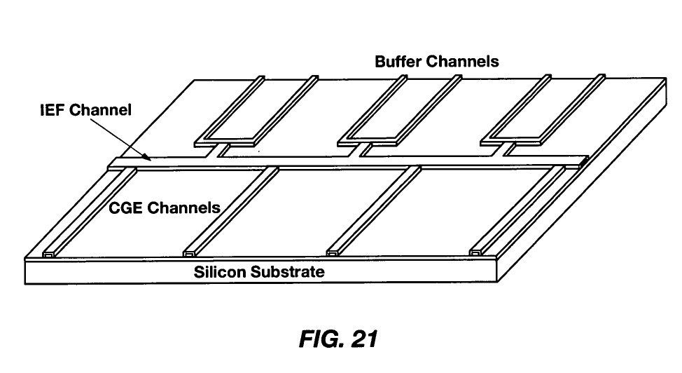

A zoom view of the intersection of the IEF channel with a few CGE channels is shown in FIG. 21. This figure shows that the looped buffer channels that allow sample injection are offset from the CGE channels to enable more efficient loading of analyte bands into the second separation dimension. Moreover, the interfaces between the different types of photopolymerized gels in the various channels are shown. Two different approaches can be used for filling the microdevices with the appropriate gels, using masked UV photopolymerization.

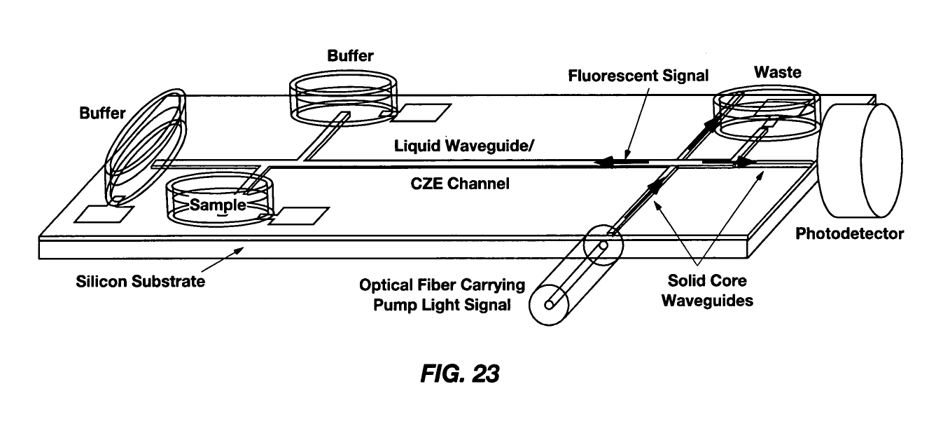

In the first method, the array of CGE channels will be filled through the common waste reservoir at the end of the CGE columns with pre-polymer solution (e.g. buffer solution having 4% acrylamide with a photoinitiator). Then an optical mask will be placed on top of the CGE channel array, which will allow UV radiation to polymerize the gel only in regions in the CGE channels (FIG. 21) up to the intersection with the IEF channel. After polymerization, residual pre-polymer solution will be flushed from the fluidic system by flowing buffer solution between the sample and buffer reservoirs, and the buffer and waste/buffer reservoirs (FIG. 20). Next, the IEF gel pre-polymer solution will be loaded into the IEF channel from the sample reservoir, acidic and basic immobilines will be added to the sample and buffer reservoirs, respectively, and a potential will be applied along the IEF channel to cause the immobilines to migrate to their appropriate positions and generate a pH gradient in the channel.¹³⁵ Then, spatially defined, UV-masked photopolymerization will create a pH gradient gel in the desired regions in the IEF channel (FIG. 23). Unpolymerized material will be removed by flushing buffer solution (FIG. 23) through the looped buffer channel.

An alternate, potentially simpler approach, involves filling the entire device with pre-polymer solution, adding acidic and basic immobilines to the sample and buffer reservoirs, respectively, and then migrating the immobilines into the IEF channel in an applied field. Masked UV polymerization will form gel in both the CGE and IEF channels, and then unpolymerized materials in the unexposed buffer channels will be flushed out. During immobiline migration for either approach it will be critical to minimize heat generation to prevent premature polymerization; therefore, a combination of low current and active device cooling will be utilized to avoid this issue.

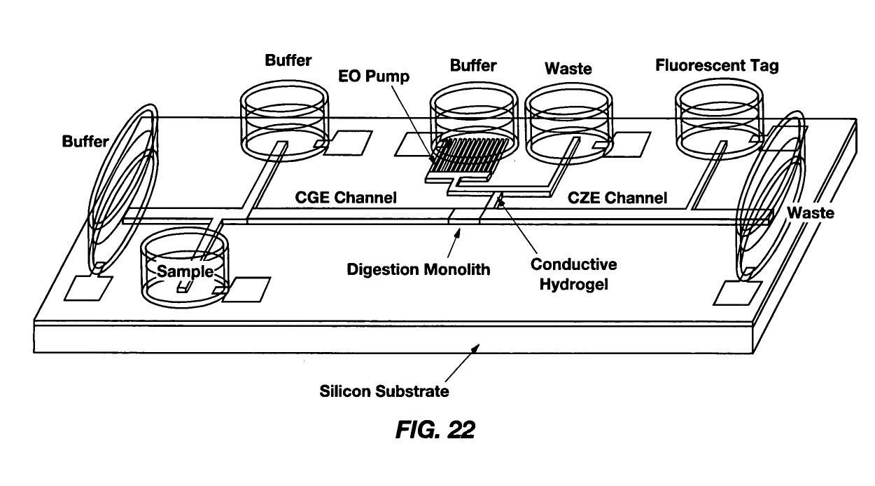

The next step is to integrate CGE, protein digestion, peptide separation and fluorescent labeling. To obtain a “peptide fingerprint” of each of the separated proteins, we will integrate CGE columns with monolithic beds for protein digestion, followed by an additional separation dimension having on-column fluorescent labeling. Appropriate design of this subsystem will enable separation-based identification of each protein analyzed, providing information similar to MS detection. A layout of a device designed for optimization of this operation is depicted in FIG. 22. This subsystem has a single injector and CGE column, which is followed by a set up for fragmenting proteins and analyzing the resultant peptides. Separate devices having different digestion enzymes will provide multiple peptide fragmentation patterns, which will allow definitive identification of the proteins being separated. On-column fluorescent labeling will be performed at the end of the separation system, enabling detection with a confocal laser-induced fluorescence setup. If greater peak capacity is desired, we can omit the enzymatic digestion monolith in the columns, and create a third separation dimension; if a conservative estimate of 20 protein bands can be separated in the CE channels, then the overall peak capacity of such a 3-D separation system would be 50,000, a substantial improvement over existing approaches.

Critical to the success of a complex planar microfluidic device is a detection system that fits into the fabrication mold outlined in previous sections. The first possibility is using an optical based technique in which analytes are tagged with a fluorophore and their presence is detected by stimulating fluorescence. The application of proteomics outlined requires hundreds to thousands of optical probe points and subsequent routing of optical signals across a chip's surface.

FIG. 23 illustrates a capillary electrophoresis separation module created from liquid waveguides. Fluorescently tagged proteins will be introduced into the module and then separated along a channel. Intersecting the liquid waveguide will be a solid core waveguide carrying an optical pumping signal. Proteins flowing through the illuminated region will emit fluorescence that will be collected and transmitted by the liquid waveguide to a downstream detector. Thin film detectors created using PECVD deposited amorphous silicon could ultimately be grown on the chip and interfaced directly with individual waveguides.

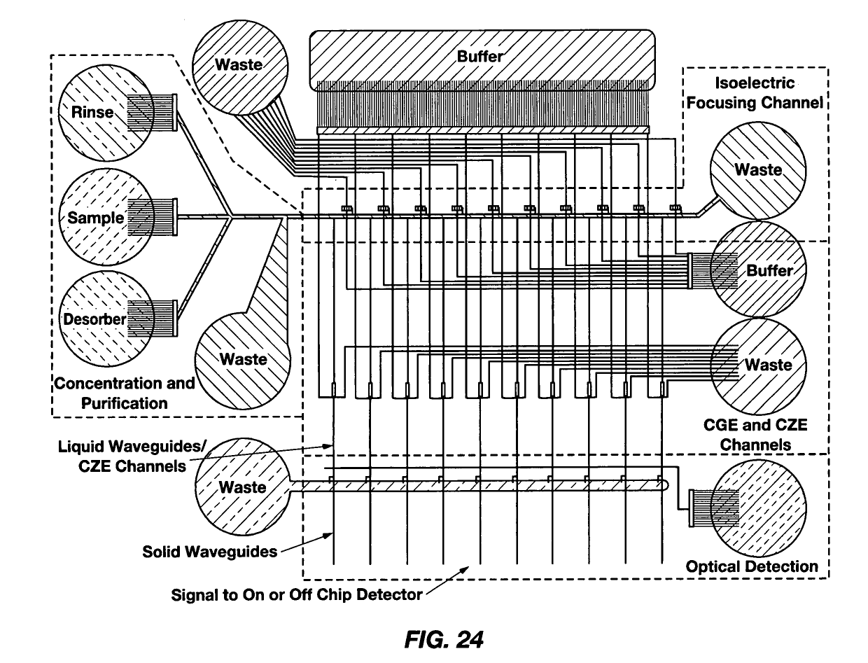

All of the optimized components described above can be integrated into a single microfluidic system for protein analysis. However, a simpler system can be constructed and described to illustrate the basic themes of the present invention. This concept is illustrated in FIG. 24.

FIG. 24 shows a schematic diagram of this simplified but fully integrated analyzer. The principal difference lies in the number of CGE channels and, hence, the number of CZE channels, fluorescent tag channels, and optical waveguide channels required.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for designing a microfluidic circuit, said method comprising the steps of:
(1) identifying design rules for spacing and width of hollow fluid channels;
(2) designing a microfluidic circuit using the hollow fluid channels; and
(3) disposing the microfluidic circuit design on a planar substrate using thin film microfabrication techniques of attachment.

2. The method as defined in claim 1 wherein the method is further comprised of the step of identifying robust designs for active microfluidic components to be used in the construction of the microfluidic circuit.

3. The method as defined in claim 2 wherein the method is further comprised of the step of selecting the active microfluidic components from the group of active microfluidic components comprising fluid pumps, separation devices, reaction systems, purification modules, concentration systems, and detectors.

4. The method as defined in claim 1 wherein the method is further comprised of the step of programming design rules for the hollow fluid channels in a microfluidic circuit computer aided drafting (CAD) program to thereby use the microfluidic circuit CAD program to design microfluidic circuits.

5. The method as defined in claim 1 wherein the method further comprises the step of providing the planar substrate that is also suitable for disposing microelectronic circuits thereon.

6. The method as defined in claim 5 wherein the method further comprises the step of disposing microelectronic circuits on the substrate, wherein the microelectronic circuits are comprised of active devices including logic, switching, communication, filtering, power circuitry, and electrical routing circuitry.

7. The method as defined in claim 6 wherein the method further comprises the step of disposing microfluidic circuits over but separate from the microelectronic circuits.

8. The method as defined in claim 7 wherein the method further comprises the step of providing electrical interconnection points between the microelectronic circuits and the microfluidic circuits.

9. The method as defined in claim 1 wherein the method further comprises the steps of:
(1) removing abundant proteins from a sample;
(2) concentrating less abundant proteins; and
(3) desorbing the concentrated proteins for separation.

10. The method as defined in claim 1 wherein the method further comprises the step of integrating an isoelectric focusing channel with a plurality of capillary gel electrophoresis channels disposed along the isolectric focusing channel to thereby generate two-dimensional separation of proteins.

11. The method as defined in claim 1 wherein the method further comprises the step of integrating a capillary gel electrophoresis channel with a monolithic enzyme digestion channel segment and a capillary electrophoresis channel to thereby obtain peptide digest profiles for identifying proteins.

12. The method as defined in claim 1 wherein the method further comprises the step of integrating on-channel detection with the capillary electrophoresis channel for the identification of analytes.

13. The method as defined in claim 12 wherein the method further comprises the step of utilizing electric impedance measurements to identify analytes.

14. The method as defined in claim 12 wherein the method further comprises the step of utilizing fluorescence emission to identify analytes.

15. The method as defined in claim 14 wherein the step of utilizing fluorescence emission further comprises the step of incorporating anti-resonant reflecting waveguide technology to transmit optical data.

16. The method as defined in claim 1 wherein the step of creating a plurality of hollow fluid channels is further comprised of the steps of:
(1) disposing a sacrificial material on the substrate in a desired layout;
(2) disposing an overcoat layer over the sacrificial material; and
(3) exposing the sacrificial material to an etchant to thereby enable the sacrificial material to be removed and thereby form the plurality of hollow channels.

17. The method as defined in claim 16 wherein the method further comprises the step of utilizing photolithography and etching techniques to thereby dispose the sacrificial material on the substrate in the desired layout.

18. The method as defined in claim 17 wherein the step of disposing an overcoat layer over the sacrificial material further comprises the step of selecting the method from the group of methods comprised of chemical vapor deposition (CVD), plasma enhanced CVD (PECVD), physical vapor deposition, sputtering, spin-on, dip-coating, electroplating, and spray coating.

19. The method as defined in claim 16 wherein the step of disposing the sacrificial material on the substrate further comprises the step of using any material having properties sufficiently different from the substrate such that the sacrificial material can be etched away leaving the substrate undamaged.

20. The method as defined in claim 19 wherein the step of disposing the sacrificial material on the substrate further comprises the step of selecting the sacrificial material from the group of sacrificial material comprising polymers, photosensitive polymers, semiconductors, silica-based dielectrics, and metals.

21. The method as defined in claim 20 wherein the method further comprises the step of selecting the sacrificial material to obtain at least one of the properties selected from the group of properties comprised of a desired cross-section for the hollow fluid channel, faster etch times, desired dimensions for the hollow fluid channel, conformality of the overcoat layer, texture of the hollow fluid channel, reduced pressure generation during etching, and using different temperatures for the overcoat process.

22. The method as defined in claim 16 wherein the step of disposing an overcoat layer over the sacrificial material further comprises the step of selecting the overcoat layer from the group of overcoat layers comprising semiconductors, insulators, ceramics, and polymers.

23. The method as defined in claim 16 wherein the step of disposing an overcoat layer over the sacrificial material further comprises the step of selecting the overcoat layer from the group of overcoat layers comprising CVD oxide and nitride, PECVD oxide and nitride, silicon nitride, silica, alumina, photosensitive resist, photosensitive epoxy and polyimide.

24. The method as defined in claim 16 wherein the method further comprises the step of selecting the substrate from the group of substrates comprised of semiconductors, insulators, polymers, ceramics, metals and glasses.

25. The method as defined in claim 1 wherein the step of designing a microfluidic circuit using the hollow fluid channels further comprises the step of forming branching structures from the hollow fluid channels.

26. The method as defined in claim 1 wherein the step of designing a microfluidic circuit using the hollow fluid channels further comprises the step of forming a first hollow channel so that it crosses over a second hollow channel.

27. The method as defined in claim 26 wherein the step of forming a first hollow channel so that it crosses over a second hollow channel further comprises the step of creating a via between the first hollow channel and the second hollow channel.
